(19) United States
(12) Patent Application Publication
(10) Pub. No.: US 2026/0145501 A1
(43) Pub. Date: May 28, 2026

(54) SKYLIGHT WINDOW ADAPTER

(71) Applicant: POLYPLASTIC B.V., EN Rotterdam (NL)

(72) Inventors: Bianca Catharina VAN BEMMEL-WELLE, Nieuwerbrug (NL); Monique Elisabeth Francisca XAVIER-ROBROEK, Den Haag (NL)

(21) Appl. No.: 19/117,265

(22) PCT Filed: Oct. 2, 2023
(86) PCT No.: PCT/IB2023/059860

§ 371 Date: Mar. 31, 2025

(30) Foreign Application Priority Data
Oct. 3, 2022 (NL) 2033212

(51) Int. Cl. B60J 7/16

(52) U.S. Cl. CPC B60J 7/1642

(57) ABSTRACT

A skylight adapter serves as an interface between a skylight opening in a structure and a skylight window. The skylight adapter includes an outer periphery with a stepped outer region having at least one step disposed between an outer flat and an inner flat, a well in the inner flat, and an inner flange defining an adapter insert that is sized corresponding to the skylight opening. The inner flange extends from and is perpendicular to an innermost perimeter of the inner flat.

### BACKGROUND

The invention relates to skylight window assemblies for recreational vehicles (RVs) and other structures and, more particularly, to a skylight adapter serving as an interface between a skylight opening in a structure and a skylight window, said skylight adapter being configured to accommodate multiple geometric shapes of the roof or sizes of roof openings.

A skylight is a desirable feature for an RV or other structure to allow sunlight into the structure and exterior roof views from inside the structure. The skylight window is sized to cover an opening in the structure, but geometric shapes or opening sizes and dimensions vary from structure to structure, and it is difficult to design a window assembly that is suitable for multiple geometric shapes of the roof or sizes and dimensions of roof openings.

Existing skylight window frames are difficult to manufacture and include rigid construction. Additionally, existing skylight window frames tend to protrude substantially from the mounting surface.

It is inter alia an object of the present invention to provide a skylight adapter that offers convenience of assembly in a roof structure, while maintaining a substantially flush profile.

### SUMMARY

In order to achieve said object a skylight adapter of the type as described in the opening paragraph, according to the invention, comprises an outer periphery including a stepped outer region, the stepped outer region having at least one step disposed between an outer flat and an inner flat; wherein the inner flat comprises an inner flange that defines an adapter insert that is sized, shaped and/or dimensioned corresponding to the skylight opening, wherein the inner flange extends from and is substantially perpendicular to an innermost perimeter of the inner flat, and wherein the inner flat comprises a window support along said innermost perimeter of the inner flat that is sized and configured to support said skylight window.

The skylight adapter according to the invention serves as an interface between a skylight opening in a structure and the skylight window. The adapter may be thermo-formed or formed of injection moulded plastic and may include a stepped outer region to accommodate multiple geometric shapes of the roof or sizes of roof openings. In some embodiments, the window support includes an integrated well or rib for receiving and mounting a seal, and near the seal is a substantially traverse inner flange that extends downward through the roof opening and into the RV or other structure.

The skylight window itself may be provided with an outer edge or rim that is received between the stepped outer region and the seal and encompasses and presses against the seal in a closed position. The skylight window connects to an aluminum hinge bar mounted to the adapter, and the opposite side of the window has locking plates or latches. The window is also preferably attached to one or more gas springs for assistance in opening the window and holding it open when desired.

### BRIEF DESCRIPTION OF THE DRAWINGS

These and other aspects and advantages will be described in detail with reference to the accompanying drawings, in which:

FIG. 1 is a perspective view of a first embodiment of a skylight window assembly including a skylight adapter of the described embodiments;

FIG. 2 shows a front view of the skylight window assembly of FIG. 1;

FIG. 3 shows a side view of the skylight window assembly of FIGS. 1 and 2;

FIG. 4 shows a bottom view of the skylight assembly of FIGS. 1 to 3;

FIG. 5A shows a sectional side view of the window assembly fo FIGS. 1 to 4;

FIG. 5B shows a detailed view of part of the sectional side view of FIG. 5A;

FIG. 6 shows a top perspective view of the adapter of FIGS. 1 to 5B;

FIG. 7A shows a bottom perspective view of the adapter of FIGS. 1 to 6;

FIG. 7B shows a detailed view of the adapter of FIG. 7A;

FIG. 8A shows a top view of the adapter of FIGS. 1 to 7;

FIG. 8B shows a sectional front view of the adapter of FIGS. 1 to 8A;

FIG. 8C shows a detailed view of FIG. 8B;

FIG. 9A shows a perspective view of a second embodiment of the window assembly including an adapter with a skylight window in an open position;

FIG. 9B shows the window assembly of FIG. 9A with the skylight window in a closed position;

FIG. 9C shows a bottom perspective view of the adapter of FIGS. 9A and 9B;

FIG. 9D shows a detailed view of part of the adapter of FIG. 9C;

FIG. 9E shows a top view of the adapter of FIGS. 9A to 9D;

FIG. 9F shows a bottom view fo the adapter of FIGS. 9A to 9E;

FIG. 10A shows a perspective view of a third embodiment of the window assembly including an adapter with a skylight window in a closed position; and

FIG. 10B shows the window assembly of FIG. 10A with the skylight window in an open position.

### DETAILED DESCRIPTION

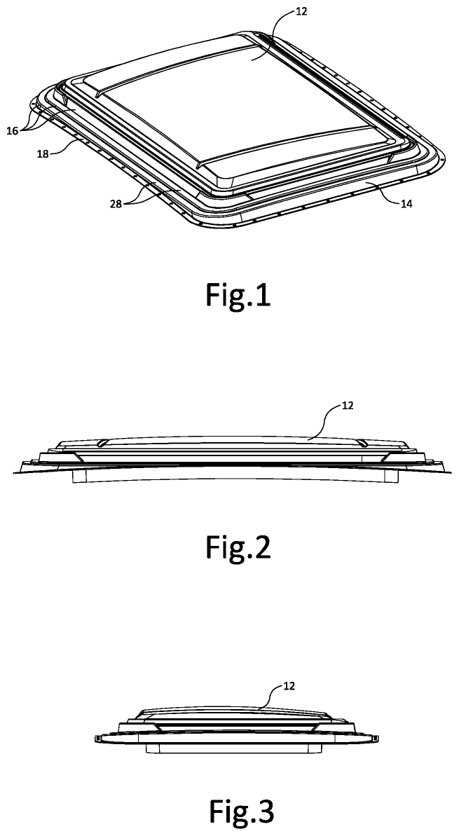

With reference to FIGS. 1 to 5B, a skylight adapter 10 serves as an interface between a skylight opening in a structure and a skylight window 12. The adapter is particularly suitable for East/West and North/South installation in the skylight opening. The skylight adapter 10 includes an outer periphery with a stepped outer region 14. The stepped outer region 14 includes at least one step 16 disposed between an outer flat 18 and an inner flat 20. As shown, the outer flat 18 may be provided with through holes for receiving connectors or the like.

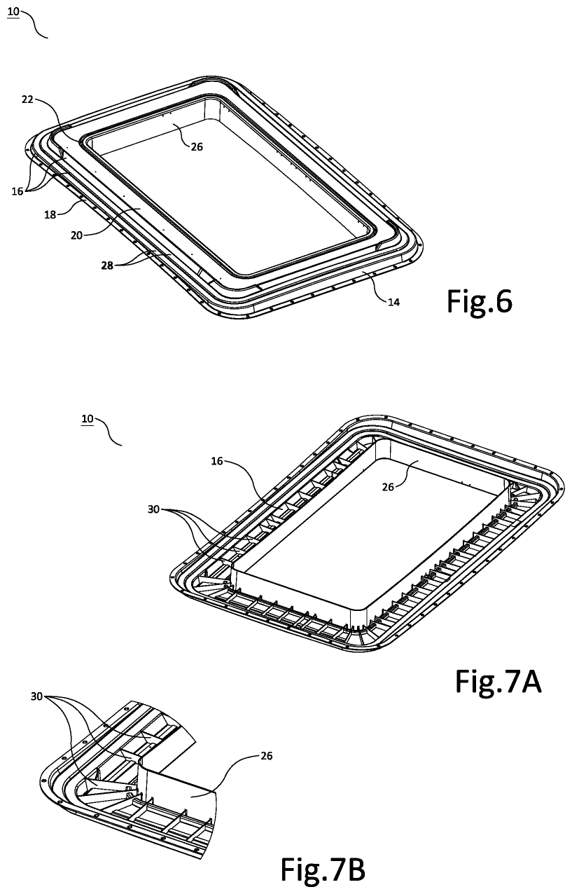

The inner flat 20 includes a window support as provided by a well 22 (FIGS. 5B and 6) that is configured for receiving and mounting a seal 24. Alternatively the inner flat may include a protruding rib instead of the well for mounting a seal. The seal may comprise an endless natural or synthetic rubber profile extending all along the well or rib. An inner flange 26 defines an adapter insert that is sized, dimensioned and/or shaped corresponding to the skylight opening. The inner flange 26 extends from and is substantially perpendicular to an innermost perimeter of the inner flat 20. In some embodiments, the inner flange 26 has rounded corners.

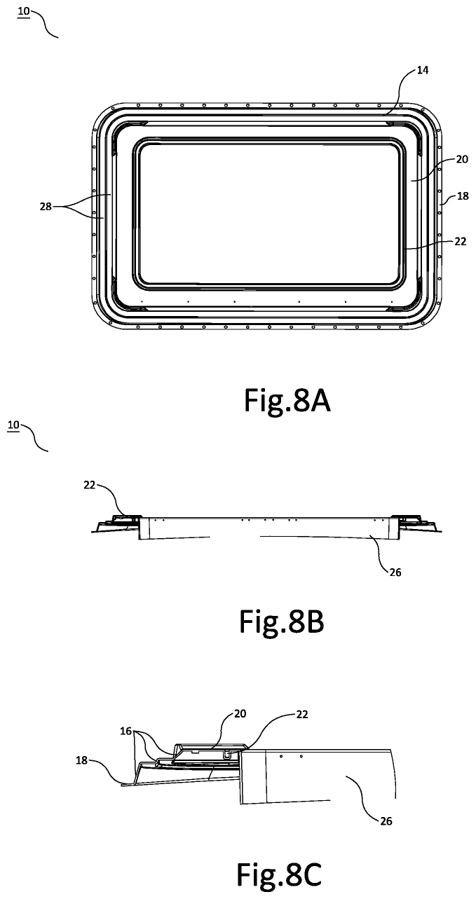

With reference to FIG. 6, in some embodiments, the outer region 14 may include at least one interior flat 28 between the outer flat 18 and the inner flat 20. FIG. 6 shows two interior flats 28 between the outer flat 18 and the inner flat 20. The flats 18, 20, 28 are separated via steps 16. FIG. 7 shows an underside of the adapter 10 shown in FIG. 6. The skylight adapter 10 shown in FIGS. 6 to 8C is preferably formed of injection moulded plastic in one of the flats 18 and 20. The adapter 10 can be modified before installation for a particular configuration via the milling process. The one-piece injection moulded adapter 10 may include monolithic support ribs 30 that connect the stepped outer region 14 to the inner vertical flange 26 for structure and strength. In FIG. 7, the ribs 30 are connected between the step 16 and the inner flange 26. In this embodiment, the wall thickness of the inner flange 26 may be formed thick enough to resist sink or compression distortion. The adapter also includes screw bosses that will accept self-tapping screws for the fasteners.

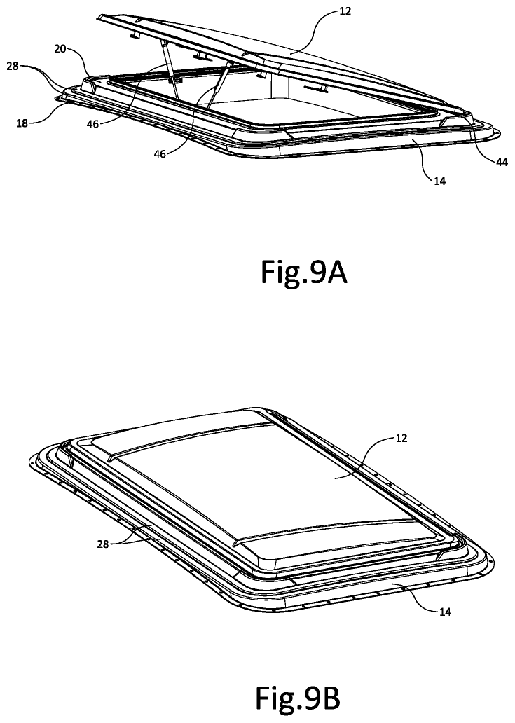

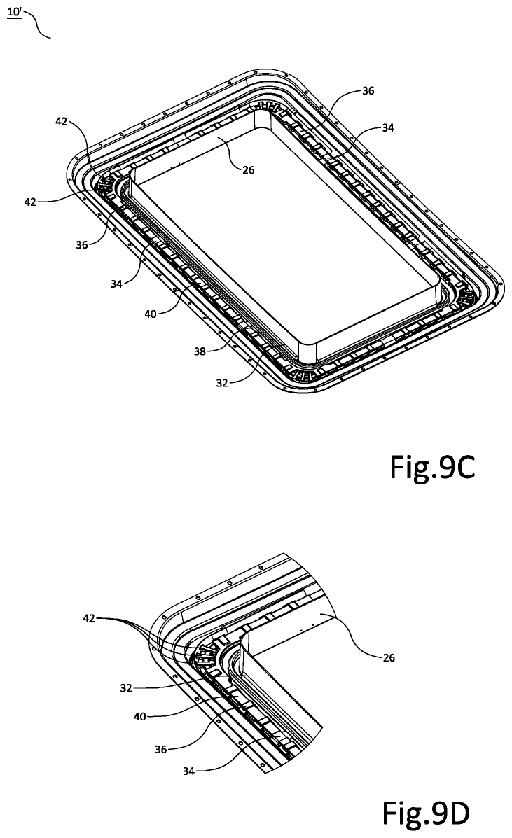

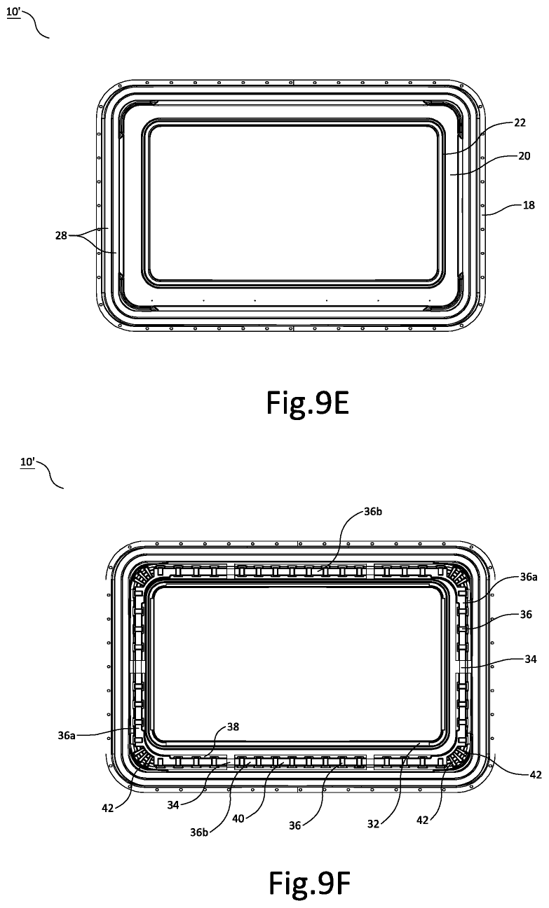

FIGS. 9A-9F illustrate a first variation of the skylight adapter 10′ incorporating one or more reinforcement bars. This variation of the adapter is thermo-formed instead of being injection moulded. One or more first reinforcement bars 32 may be secured against the inner flange 26 (see FIG. 9C to 9D). The first reinforcement bars 32 may be secured via an adhesive or the like. The adapter 10′ may also include one or more second reinforcement bars 34 secured to the inner flat 20.

As shown in FIG. 9C, the one or more second reinforcement bars 34 may be secured to the inner flat 20 via an insert 36 including connecting surfaces 38 configured to be secured to the inner flat 20 and including a recess 40 for receiving the one or more second reinforcing bars 34. The insert 36 may include ribs 42 to increase the stiffness of the insert 36 and its structural integrity. The assembly may include multiple inserts 36 securing the multiple second reinforcement bars 34. In the embodiment shown in FIG. 9F, the insert 36 is comprised of four right-angle molded plastic components 36a and two linear molded plastic components 36b.

The first reinforcement bars 32 and the second reinforcement bars 34 may be metal such as aluminum or other suitable material such as PVC or the like and may vary slightly in location depending on the configuration for which the adapter is milled. The first reinforcement bars 32 and the second reinforcement bars 34 may be added after milling to add strength and reinforcement.

The wall thickness of the inner flange 26 in the embodiment shown in FIGS. 9C to 9F may have a lesser thickness than the wall thickness of the inner flange 26 in the embodiment shown in FIGS. 6 to 8C. For example, the wall thickness of the inner flange 26 in FIGS. 6 to 8C may be about 25% greater than the wall thickness in the embodiment shown in FIGS. 9C to 9F.

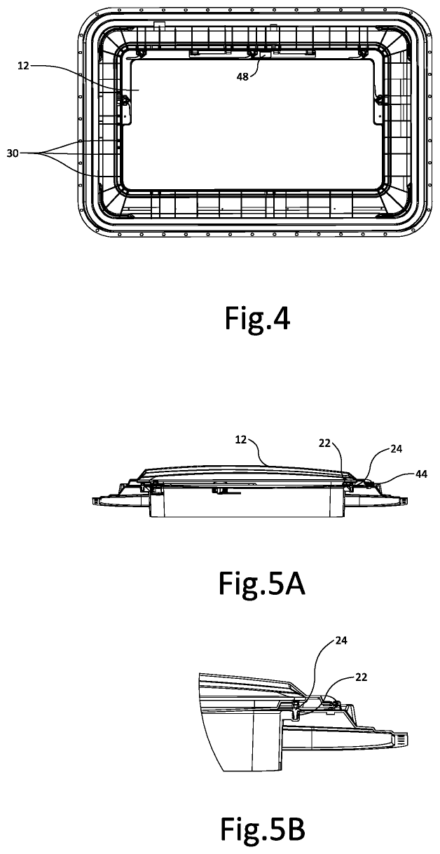

With continued reference to FIGS. 1 and 9A, the overall skylight window assembly includes the adapter 10, 10′ of the described embodiments and the skylight window 12 pivotally coupled with the skylight adapter 10, 10′. With reference to FIG. 9A, a hinge 44 is secured to the inner flat 20 of the skylight adapter 10, 10′, and the skylight window 12 is pivotable on the hinge 44 between a closed position and an open position. One or more gas springs 46 may be connected between the skylight adapter 10, 10′ and the skylight window 12 on a side of the skylight adapter opposite from the hinge 44. The gas spring 46 biases the skylight window 12 toward the open position. FIG. 4 also shows a latch 48 connected to the skylight adapter 10 and positioned to secure the skylight window 12 in the closed position. The latch 48 is cooperable with corresponding latching structure secured to the skylight window 12.

The adapter of the described embodiments is formed of a mouldable plastic construction, enabling the design to accommodate multiple roof configurations, shapes and/or dimensions and sizes for a skylight opening. The adapter is fairly low-profile and does not extend high above the roof while maintaining structure and durability. The positioning of the window seal closer to the inner flange rather than the outer flat better accommodates varying window sizes while maintaining a secure seal between the window and the adapter.

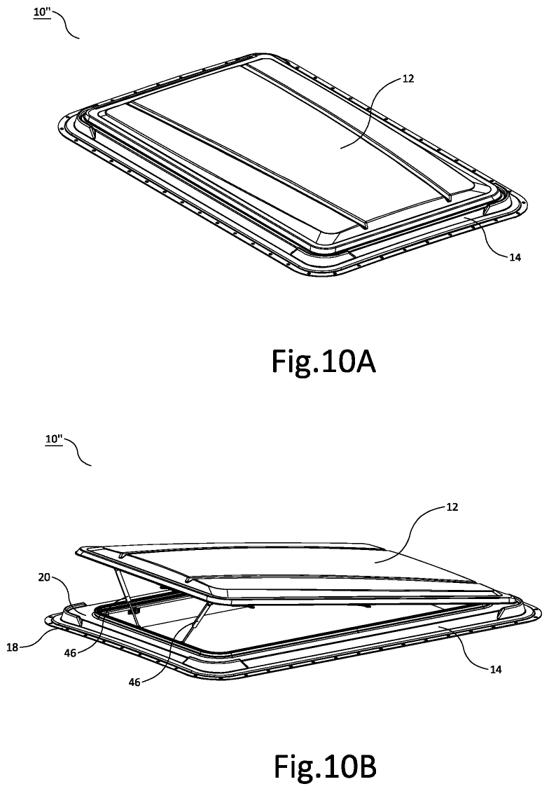

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims. For example, as shown in FIGS. 10A and 10B, a second variation of a thermo-formed skylight adapter 10″ is configured to receive a skylight window 12 which is openable at a short side of the adapter 10″.

1. A skylight adapter serving as an interface between a skylight opening in a structure and a skylight window, the skylight adapter comprising an outer periphery including a stepped outer region, the stepped outer region having at least one step disposed between an outer flat and an inner flat;
wherein the inner flat comprises an inner flange that defines an adapter insert that is sized, shaped and/or dimensioned corresponding to the skylight opening,
wherein the inner flange extends from and is substantially perpendicular to an innermost perimeter of the inner flat, and
wherein the inner flat comprises a window support along said innermost perimeter of the inner flat that is sized and configured to support said skylight window.

2. A skylight adapter according to claim 1, wherein said window support comprises a well or a rib of said inner flat.

3. A skylight adapter according to claim 2, further comprising a seal secured to the window support, said seal particularly comprising a natural or synthetic rubber profile extending along said window support.

4. A skylight adapter according to claim 1, wherein the stepped outer region comprises at least one interior flat between the outer flat and the inner flat.

5. A skylight adapter according to claim 1, further comprising reinforcing ribs on an underside of the skylight adapter extending between the step and the inner flange.

6. A skylight adapter according to claim 1, wherein the inner flange defining the adapter insert comprises rounded corners.

7. A skylight adapter according to claim 1, further comprising at least one first reinforcement bar secured against the inner flange, preferably comprising a plurality of first reinforcement bars secured against each side of the inner flange.

8. A skylight adapter according to claim 7, further comprising at least one second reinforcement bar secured to the inner flat.

9. A skylight adapter according to claim 8, wherein the at least one second reinforcement bar is secured to the inner flat via an insert including connecting surfaces configured to be secured to the inner flat and including a recess for receiving the at least one second reinforcement bar.

10. A skylight adapter according to claim 9, wherein the insert comprises ribs.

11. A skylight window assembly for mounting in a skylight opening in a structure, the skylight window assembly comprising:
a skylight adapter comprising:
an outer periphery including a stepped outer region, the stepped outer region having at least one step disposed between an outer flat and an inner flat,
a window support in the inner flat, and
an inner flange defining an adapter insert that is sized, shaped and/or dimensioned corresponding to the skylight opening, wherein the inner flange extends from and is substantially perpendicular to an innermost perimeter of the inner flat; and
a skylight window pivotally coupled with the skylight adapter and resting on the window support, at least in a closed position.

12. A skylight window assembly according to claim 11, further comprising a hinge to which the skylight window is pivotally attached, the hinge being secured to the stepped outer region of the skylight adapter.

13. A skylight window assembly according to claim 12, further comprising a gas spring connected between the skylight adapter and the skylight window on a side of the skylight adapter opposite from the hinge, the gas spring biassing the skylight window toward an open position.

14. A skylight window assembly according to claim 11, further comprising a latch connected to the skylight adapter and positioned to secure the skylight window in a closed position.

15. A skylight window assembly according to claim 11, wherein the stepped outer region comprises at least one interior flat between the outer flat and the inner flat.

16. A skylight window assembly according to claim 11, further comprising a seal secured to the window support.

17. A skylight window assembly according to claim 11, wherein the window support comprises a well or a rib along said skylight opening.

18. A skylight window assembly according to claim 11, further comprising reinforcing ribs on an underside of the skylight adapter extending between the step and the inner flange.

19. A skylight window assembly according to claim 11, further comprising at least one first reinforcement bar secured against the inner flange.

20. A skylight window assembly according to claim 19, further comprising at least one second reinforcement bar secured to the inner flat.

21. A skylight window assembly according to claim 20, wherein the at least one second reinforcement bar is secured to the inner flat via an insert including connecting surfaces configured to be secured to the inner flat and including a recess for receiving the at least one second reinforcement bar.
